(19) United States
(12) Patent Application Publication
(10) Pub. No.: US 2026/0308030 A1
(43) Pub. Date: Oct. 8, 2026

(54) TWO-SLUDGE WATER REUSE PROCESS

(71) Applicants: Eugenio Giraldo, Robbinsville, NJ (US); Barbara Wingler, Robbinsville, NJ (US)

(72) Inventors: Eugenio Giraldo, Robbinsville, NJ (US); Barbara Wingler, Robbinsville, NJ (US)

(21) Appl. No.: 19/172,618

(22) Filed: Apr. 7, 2025

(51) Int. Cl. C02F 3/00; C02F 3/12

(52) U.S. Cl. CPC C02F 3/006; C02F 3/1236; C02F 2209/003; C02F 2209/08; C02F 2209/14; C02F 2209/15; C02F 2209/16; C02F 2209/40; C02F 2301/046; C02F 2301/08

(57) ABSTRACT

Systems and methods for cost efficiently producing water for reuse using a two-sludge process are described. Savings are realized compared to current art while producing reuse water and recovering nutrients. Savings are due to decreases in both alkalinity chemicals for nitrogen removal and energy for nitrification, as well as elimination of added carbon and decreased biosolids disposal needs for denitrification. In some cases, fertilizer that meets the requirements of the USDA National Organic Program can be produced using the described systems and methods.

### RELATED APPLICATIONS

This regular utility non-provisional patent application claims priority benefit with regard to all common subject matter of U.S. Provisional Patent Application Ser. No. 63/631,531, filed Apr. 9, 2024, entitled “TWO SLUDGE WATER REUSE PROCESS”. The above-identified patent application is hereby incorporated by reference in their entirety into the present patent application.

### BACKGROUND

Two-sludge systems have been widely used over the last several decades for treatment of wastewaters of industrial, agricultural and municipal origin due to the inherent flexibility that the two-sludge system provides for treatment. In the two-sludge system, as its name implies, two sludge systems are used in series. The first-stage system receives the wastewater to be treated and the second stage system receives the effluent of the first stage system. Each of the stages are operated at different loading rates and sludge residence times, SRTs, in such a way that the first stage is predominantly a carbonaceous BOD removal system, while the second stage is a nitrogenous BOD processing system. The microbiological characteristics of the sludge that forms in each of the systems are different; the sludge from the first stage, the first stage sludge, is comprised of mostly heterotrophic organisms while the sludge from the second stage, the second stage sludge, is comprised of microorganisms that oxidize nitrogenous compounds. The main advantage of the two-sludge system is that it enables independent control of the conditions for carbonaceous BOD, CBOD, and nitrogenous BOD, NBOD, removals thus achieving an overall more efficient and reliable removal of total BOD, both carbonaceous and nitrogenous. One main criticism of the two-sludge process is that while it is efficient for removal of both carbonaceous and nitrogenous BOD, it does not remove nutrients such as phosphorus. With the advent of the need for nutrient removal, namely nitrogen and phosphorus removal, modifications to the two-sludge process have been proposed to not only remove BOD but to also remove nutrients. For example, modifications to the two-sludge system have been presented in Patent EP0527123B1 to achieve nitrogen and phosphorus removal. In the original two-sludge process the first stage of the two-sludge process is solely aerobic, with no anoxic or anaerobic zones. With the proposed modification of Patent EP0527123B1, anaerobic and anoxic zones for achieving denitrification and biological phosphorus removal are incorporated in the first stage. In addition, return of second stage sludge to the first stage is included in the patent. This return of second stage sludge to a first stage anoxic tank induces denitrification, and internal return of sludge in the first stage to the anaerobic zone induces biological phosphorus removal.

The system described has been named a two-sludge hybrid system due to the mixing of first and second stage sludges that occurs with the return of the sludge from the second stage to the first stage. The two-sludge hybrid system is mostly used in Europe in municipal wastewater treatment applications for removal of nitrogen and phosphorus, via denitrification and biological phosphorus removal, respectively. Other variations of the two-sludge concept have been developed such as the use of roughing treatment processes for removal of carbonaceous BOD, such as in moving bed biofilm reactors, MBBRs, or fluidized bed reactors with high loading rates. In these applications, no return of sludge to a first stage is practiced per se; the biofilm growing and retained on the media within the bioreactor is considered to perform the function of the returned sludge. For the purpose of this invention, these roughing carbonaceous BOD only removal processes (i.e., no nitrogenous BOD removal) are considered to be the first stage of a two-sludge process.

Treatment of industrial or agricultural wastewaters of high nitrogen concentrations with the prior art two-sludge process requires pH control chemicals and external carbon for denitrification, thus increasing processing costs. A base is usually needed for pH control when total nitrogen concentration in the influent wastewater is greater than 80 mg/L since pH is depressed during nitrogenous BOD, NBOD, removal. External carbon for denitrification is needed when COD to total nitrogen ratio is below 6. Use of external carbon for denitrification is also routine practice when municipal wastewater treatment plant limits for total nitrogen in effluent are less than 10 mg/L and also for industrial wastewater treatment of effluents from food or fertilizer industries, ammonia condensates, landfill leachates, manures, livestock waste or other agricultural wastewaters. External carbon used for denitrification, such as methanol, often comes from fossil fuel sources thus increasing the carbon footprint of wastewater treatment system. Alternative sources of carbon can be obtained; however, they are typically cost-prohibitive and, in some cases, when produced from within the plant, use systems that are capital intensive and complex to operate. The present invention eliminates the need for pH control chemicals during nitrification, and the need for external carbon addition for denitrification while employing a two-sludge treatment process.

The current trend in industrial, agricultural and municipal applications favors the production of reuse water, i.e., high quality water produced from treated wastewater. As such, there is a need not only to remove nutrients but also to remove other dissolved, i.e., soluble, constituents in wastewater, including pharmaceutical compounds, trace organics, and inorganic dissolved solids. The use of soluble constituent treatment processes is now considered a follow-up stage to traditional wastewater treatment. For example, advanced oxidation processes and granular activated carbon are often used for removal of trace dissolved organic contaminants. Membrane processes such as nanofiltration, or reverse osmosis or electrochemical processes such as capacitive deionization, here presented as examples as others exist, are used after biological processes to remove soluble, i.e., dissolved, constituents. The effluent after the soluble material treatment process, substantially devoid of dissolved material, is then appropriate for use as reuse water and a brine containing the concentrated soluble substances is removed and further treated or disposed of. Processes that further treat the brine would be applicable to some cases of Zero Liquid Discharge, ZLD, processes where it is necessary to minimize brine disposal challenges. Ammonia becomes a problem for handling brines and for processes that further treat brines. Ammonia combines with phosphorus in the brine to produce precipitates and enhances precipitate formation of carbonates and other salts by increasing the pH of the solution. Free ammonia, NH3, also permeates easily across membranes, thus limiting the use of membranes for its removal downstream.

The present invention combines the benefits of a two-sludge system for carbonaceous and nitrogenous BOD removal with the elimination or minimization of chemicals for nitrogen removal and denitrification. Elimination or reduction of chemical use for pH control during nitrification is achieved by controlling the nitrification conversion efficiency. External carbon for denitrification reduction is achieved by elimination of or minimalizing denitrification. Energy expense required for nitrogenous BOD, NBOD, processing is also decreased significantly since only a fraction of the NBOD is oxidized. Furthermore, the amount of excess sludge to be processed is reduced since no external carbon for denitrification is used, thus avoiding the growth of denitrifying organisms. The use of the two-sludge process enables optimization of the carbonaceous BOD removal and NBOD removal independently, thus achieving more stable operation by removing toxic compounds in the first stage that would inhibit nitrifying organisms present in the second stage. When treating wastewaters with concentrations of total nitrogen higher than 100 mg/L, upstream recirculation of treated effluent with low ammonia concentration enables steady operation of the second stage by diluting the ammonia concentration and avoiding ammonia toxicity. By employing the present invention, high quality reuse water is produced and processing of brine produced by a soluble substance treatment process is improved since controlled nitrification eliminates ammonia associated issues. Furthermore, by avoiding the removal of nitrogen in the process and achieving controlled nitrification without the addition of any chemicals the brine produced is rich in nutrients that can be used as fertilizers in organic agriculture.

Another contribution of the present invention is the ability to produce fertilizer products that can be compliant with the National Organic Program (NOP) by recovering the nutrients in wastewater in a way that avoids the use of synthetic chemicals as used in prior art. The methods and systems in the present invention can produce a fertilizer that complies with the NOP policies and requirements for use in organic production and handling.

The National Organic Program (NOP) is a regulatory framework established by the United States Department of Agriculture (USDA) to oversee and standardize organic agricultural practices in the country. Enacted as part of the Organic Foods Production Act of 1990, the NOP aims to ensure the integrity of organic products and provide consumers with confidence in the organic label. The NOP plays a pivotal role in promoting sustainable agriculture and supporting the growth of the organic industry in the United States. Under the NOP, farmers, ranchers, and food processors must adhere to strict guidelines governing the production and handling of organic goods. These guidelines encompass various aspects of agricultural practices, including soil fertility, pest and disease control, livestock management, and processing methods. Certified organic producers are required to use natural inputs, such as organic fertilizers and pesticides, and to avoid the use of synthetic chemicals, genetically modified organisms (GMOs), and irradiation. The present invention enables production of organic fertilizers in compliance with rules and regulations of the NOP.

To achieve and maintain organic certification, organic producers and handlers undergo a rigorous inspection process conducted by USDA-accredited certifying agents that includes providing a list of each material in their Organic System Plan (OSP). Certifying agents are responsible for evaluating this list to determine NOP compliance before producers are allowed to use any listed material in their operation. Certifiers may use any or all of the following available options to aid in their review process: 1) self-perform a detailed review of product, all ingredients, manufacturing processes, source materials, and processing aids used to produce the ingredients and/or final product, 2) consult with another accredited certifier who has already evaluated the product and accept that certifier's determination of compliance, 3) only for the case of pesticides, accept those determined by USEPA to comply, or 4) consult with Material Review Organizations (MROs) such as the Organic Materials Review Organization (OMRI) for organic crop and livestock materials and materials used in organic handling, and California Department of Agriculture (CDFA) Organic Input Material (OIM) program for organic crop materials.

MROs are independent third-party organizations recognized by the USDA and accredited to assess the compliance of materials with organic regulations. They evaluate substances based on established criteria, considering factors like environmental impact, compatibility with organic practices, and whether there are suitable organic alternatives available. MROs also play a vital role in the National Organic Program (NOP) by reviewing and making recommendations to the National Organic Standards Board (NOSB), an advisory body to the USDA, which then decides whether to allow or prohibit the use of specific substances in organic production. The involvement of MROs helps maintain the transparency and credibility of the organic certification process. By conducting thorough reviews, these organizations contribute to the overall goal of ensuring that organic products meet stringent standards for environmental stewardship and consumer expectations. The collaboration between MROs, the NOSB, and the USDA is crucial in upholding the integrity of the National Organic Program and supporting the growth of the organic industry.

### SUMMARY OF THE INVENTION

A new process for treating wastewater containing CBOD and NBOD avoiding the use of chemicals for pH control and denitrification in current art and cost effectively producing useful and valuable products by using a two sludge process where the nitrification reactions in the second bioreactor are dynamically controlled within to a fraction of the influent NBOD avoiding the use of chemicals, reducing the amount of energy for aeration and reducing the production of sludge from denitrification, conserving nutrients for reuse. Further treatment and concentration of the effluent by removing soluble constituents after the controlled nitrification process in included producing high quality reuse water and a concentrate rich in nutrients that can be easily stored and used as a fertilizer which in many cases is compliant with the National Organic Program rules and regulations. Return of high-quality treated water with reduced concentration of ammonia to the process upstream enables dilution of ammonia to control toxicity associated to high concentrations of ammonia in influent wastewater. In some applications the use of a first CBOD removal process is not necessary, and the influent wastewater is directed directly to the controlled nitrification process.

### BRIEF DESCRIPTION OF FIGURES

FIG. 1A illustrates one embodiment of the present invention where a two-sludge process is used with controlled nitrification in the secondary bioreactor.

FIG. 1B illustrates yet another embodiment of the present invention where the first bioreactor is a roughing CBOD removal bioreactor, and the second bioreactor is a controlled nitrification bioreactor.

FIG. 1C illustrates yet another embodiment of the present invention where no CBOD removal bioreactor is used and influent wastewater is directed to the controlled nitrification bioreactor.

FIG. 2 illustrates an embodiment of the present invention including a soluble material treatment of the concentration of nutrients and production of high-quality water amenable for reuse.

FIG. 3 illustrates an exemplary application of the principles of control of the present invention to dynamically control the nitrification reaction in a nitrifying bioreactor.

FIG. 4 illustrates the economic benefits of the present invention to an exemplary industrial wastewater application.

### DETAILED DESCRIPTION

Aspects and embodiments disclosed herein are not limited in application to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

In any embodiment of the present invention the concentration of ammonia in any of the bioreactors where nitrification is taking place is many times more than the ammonia half saturation constant for nitrifiers. This is the case because in the current embodiment only a fraction of the ammonia is oxidized, nitrified, so ammonia concentration remains relatively high when compared to the half saturation constant. The half saturation constant of total ammonia nitrogen for nitrifiers is typically 1 mg/L NHx-N, where the “NHx” symbolizes total ammonia nitrogen, the combined concentration of ammonium NH4+ and free ammonia NH3 Even in more dilute wastewaters, such as municipal sewage where the current invention would typically be applied, the concentration of nitrogen compounds is about 40-90 mg N/L. Since only a fraction of the ammonia is nitrified in a typical embodiment, for example only 40-60%, the concentration of NHx-N in the effluent of the nitrification reactor would be 20-45 mg/L. The ratio of NHx-N to the half saturation constant is then at least 20, even in a relatively low nitrogen application such as municipal sewage. When the concentration of NHx-N in said reactors where the nitrification reactions are taking place is many times higher than the half saturation constant, Monod kinetics of nitrification is in the saturation phase, and the rate of reaction becomes zero order, that is, independent of the concentration of NHx-N. Consequently, the rate of nitrification is described as:

$$R nitrification = \frac{{μ}_{max , nitrifiers}}{Y} {X}_{nitrifiers} \qquad ( 1 )$$

Where:
Rnitrification=rate of nitrification in mass of NHx-N nitrified per volume of reactor and per unit time
μ_{max,nitrifiers}=maximum growth rate of nitrifier bacteria at a given condition, in per unit time
X_{nitrifiers}=concentration of nitrifiers in the bioreactor, mass of nitrifier biomass per unit volume
Y=bacterial yield of nitrifiers, mass of nitrifier bacteria per mass of NHx-N

For a given short term operational condition of a bioreactor where disturbances to the process can take place within minutes, as when treating municipal sewage or industrial or agro-industrial effluents, all the terms in Equation (1) are constant. The maximum growth rate of nitrifiers and the yield coefficient are widely available in technical literature. The amount of nitrifiers can be considered constant for a short-term control operation like the one considered in the present invention and can be independently controlled as part of the design of the system. Growth of nitrifiers is slow, in the order of days, while the controls necessary for appropriate operation are in the order of minutes. Hence, for a given operational condition of the bioreactor, a given amount of nitrifiers, the nitrification rate is constant and the concentration of NHx-N in the effluent can be controlled by controlling the rate of introduction of nitrogen into the bioreactor. For example, for a continuous flow completely mixed bioreactor, exemplary of aerated nitrifying bioreactors in the present invention, the performance of the bioreactor is described by the following equation:

$$Q ( {S}_{n}^{o} - {S}_{n}^{e} ) = {R}_{nitrification} V \qquad ( 2 )$$

Where:
Q=volumetric flow rate in and out of the bioreactor, volume per unit time
R_{nitrification}=Rate of nitrification as per equation (1)

V=volume of the bioreactor

$${S}_{n}^{o} = influent NHx - N$$

concentration to the bioreactor in mass per unit volume

$${S}_{n}^{e} = effluent NHx - N$$

concentration to the bioreactor in mass per unit volume

Defining the fraction of influent nitrogen that is nitrified as

$$η = \frac{{S}_{n}^{o} - {S}_{e}^{o}}{{S}_{n}^{o}}$$

then Equation (2) can be reorganized as:

$$η = \frac{{R}_{nitrification}}{{S}_{n}^{o}} \frac{V}{Q} \qquad ( 3 )$$

Equation (3) indicates that the fraction of nitrogen that is nitrified, η, can be controlled by controlling the flow rate to the bioreactor, Q, for a given operational condition of the bioreactor, namely a given nitrification rate, R_{nitrification}, a given bioreactor volume, V, and for a given influent nitrogen concentration,

$${S}_{n}^{o} .$$

Hence, one can select 10% conversion, or 20% conversion or 30% conversion or 50% or 60%, or others as needed by controlling the influent flow rate to the bioreactor Q. With the use of the present invention the nitrified fraction η can be selected in such a way that no addition of excess alkalinity is necessary, only using the incoming wastewater alkalinity thus enabling large operational savings. In any case, alkalinity can always be added to achieve a desired nitrified fraction that consumes more of the incoming alkalinity, this fraction of influent nitrogen nitrified fraction where more alkalinity is needed is usually higher than 50%.

In practical applications of the process, influent concentrations of nitrogen containing compounds,

$${S}_{n}^{o} .$$

are variable and can be subject to short term variations, in the orders of minutes or hours in some cases, or seasonally, or weekly. One can see from equations (2) and (3) that if the influent concentration to the bioreactor,

$${S}_{n}^{o} ,$$

is variable the flow rate, Q, that the bioreactor can process to maintain the desired influent nitrified fraction, η, must be also adjusted accordingly. This leads to a dynamic control of the nitrification process where the influent flow rate, Q, to the nitrifying reactor is adjusted dynamically to achieve the desired influent nitrified fraction target. One can measure the ammonia in the effluent from the bioreactor and use that as a target concentration and increase or decrease the influent flow rate, or measure the nitrate or nitrite concentrations, i.e., the product of the nitrification reactions, and set those as target and adjust the influent flow rate accordingly. Furthermore, one can measure all of these in the effluent, ammonia and the products nitrate and nitrite, or gaseous products, nitric oxide or nitrous oxide, and use a combination of those measurements to drive the control of the influent flow rate to the bioreactor. In some cases, one can also include a measurement of ammonia in the influent to the bioreactor and combine those measurements with the effluent measurements to drive the decision of the flow control to the bioreactor. A large variety of control strategies can then be devised by someone skilled in the art to reach the desired conversion under dynamic conditions typical of operations and PID controls, sampling times, sampling responses, dead bands, and others can be selected as part of the control. The underlying common control structure, in any case, is based on measuring a concentration of substrate for nitrification, or measuring the products of nitrification in the bioreactor or in the effluent to the bioreactor, or both, and optionally measuring the concentration of total nitrogen or ammonia nitrogen in the influent to the bioreactor, and using said measurements to control the influent flow to the bioreactor. The substrate for nitrification is ammonia, ammonium or total ammonia nitrogen, and the products of nitrification are nitrate or nitrite or both, or other products of nitrification that might be gaseous such as nitric oxide or nitrous oxide. Said measurements are processed and the influent flow rate to the bioreactor is controlled to achieve a desired effluent of ammonia, ammonium, nitrate, nitrite or a combination of those. The effluent ammonia or ammonium or total ammonia NHx-N, or nitrate can be then set to a desired set point, or a desired range of concentrations within a range, and the influent flow rate to the bioreactor controlled to achieve the desired effluent condition. A most advantageous application of the controlled nitrification process of the present invention is when no alkalinity other than the alkalinity present in the influent wastewater is used for treatment. In contrast with prior art, 100% of the alkalinity additions necessary for full nitrification are avoided with large savings to operations especially when industrial or agro-industrial wastewaters with high concentrations of nitrogen are treated. Additionally, because only a fraction of the nitrogen is nitrified, significant savings in aeration energy for nitrification are also accrued and, furthermore, because no denitrification reactions are encouraged in the present invention, savings in external carbon sources for denitrification are also accrued. Biosolids production is also reduced because of the avoidance of carbon for denitrification and the associated growth of denitrifying organisms. However, the use of dissolved solids treatment downstream is an additional cost of the process; however, in many cases the savings accrued are more than the cost of additional dissolved solids treatment.

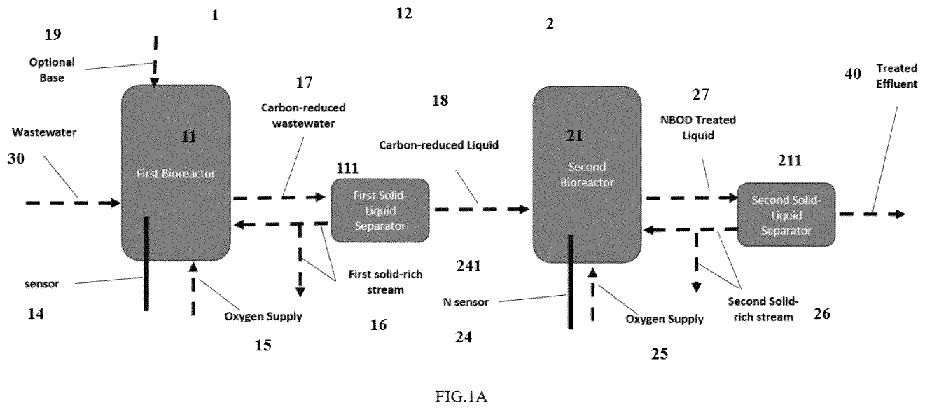

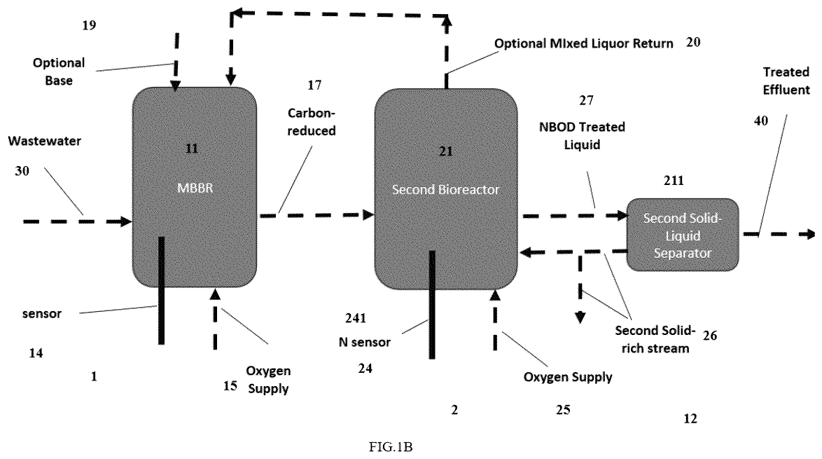

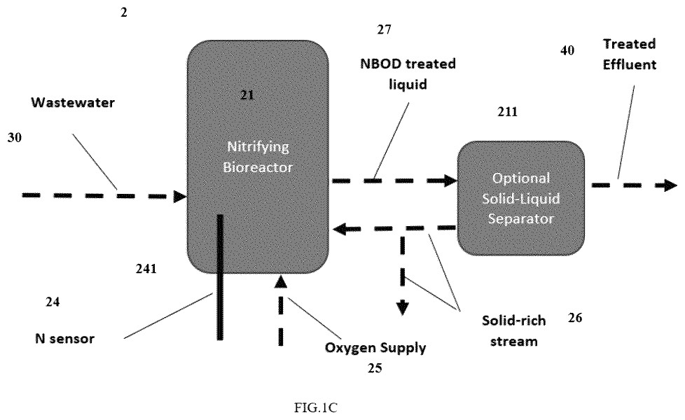

FIG. 1A represents one embodiment of this invention where a two-sludge process 12 is presented including a first stage 1 with a first bioreactor 11 and a first solid-liquid separator 111, and a second stage 2 with a second bioreactor 21 and a second solid-liquid separator 211. The first stage bioreactor receives the wastewater 30 containing CBOD and NBOD; this first stage is operated at loading rates and sludge residence times, SRTs, such that CBOD is preferentially oxidized using oxygen supply 15 and producing a carbon-reduced wastewater 17 that is directed to the first solid-liquid separator 111. An optional sensor 14 for measurement of influent nitrogen concentration or nitrogen in the first bioreactor can be used to inform the loading rate of nitrogen to the second-stage process 2 downstream and could be integrated into the control process of the second-stage ammonia effluent control system. Optional sensor 14 can be an ammonium ion sensor, or free ammonia sensor, or organic ammonia sensor, or total nitrogenous compounds sensor. In some embodiments, other sensors, such as a conductivity sensor, could also be used for controlling the amount of dilution that occurs from the recirculation from downstream, and a dissolved oxygen sensor or an oxidation reduction potential sensor could also be used for controlling dissolved oxygen concentration in the bioreactor and those as considered part of sensor 14. In the first solid-liquid separator 111, sludge is preferentially separated from the carbon-reduced wastewater 17, thus forming a first solid-rich stream 16 and a carbon-reduced liquid 18 substantially devoid of sludge that is directed to the second stage 2. The first-stage bioreactor can include a biological phosphorous removal bioreactor such as but not limited to a Phostrip, or A/O process or any other biological phosphorus process removal configuration that does not incorporate nitrification and denitrification. Someone skilled in the art will find an appropriate application for a given wastewater where phosphorus removal is desired in the first stage. The first process 1 may receive an optional base 19 to provide alkalinity when the desired conversion of ammonia in the second process 2 is more than 50% but less than 90%. This addition is considered optional as the most advantageous application of the present invention is when no alkalinity is used to eliminate expenses compared to current art. Even though FIG. 1A has the alkalinity addition 19 going to the first process 1, said addition 19 may be directed to the second process 2 as needed. A second bioreactor 21 receives oxygen supply 25 to preferentially oxidize NBOD to form oxidized nitrogen compounds, namely nitrate and/or nitrite, forming a NBOD-treated liquid 27 that is conveyed to the second solid-liquid separator 211. The second bioreactor is operated with loading rates and SRTs such that microorganisms responsible for oxidation of NBOD are present. The fraction of influent nitrogen that is nitrified is controlled using a monitoring and control subsystem 241 by measuring the concentration of ammonia, or ammonium, or nitrite or nitrate or a combination of those with the N sensor 24 and selecting an effluent concentration of either or all of these parameters at a desired set point or a desired range. Accordingly, the NBOD treated liquid 27 would have only a fraction of the ammonia nitrified as per the desired set point or desired range. After the second solid-liquid separator 211 two streams are produced, a second solid-rich stream 26 that is partially returned to the second bioreactor or partially wasted to control SRT, and a treated effluent stream 40. Wasting of sludge in the first and second bioreactors is controlled independently creating two separate SRTs, one for the first stage and one for the second stage. Many different types of bioreactors can be used for oxidizing NBOD; suspended growth and biofilm reactors, reactors with mobile biofilms, or static biofilms, or flocculent sludge or granular sludge, reactors with membranes for support or aeration or alternative oxygen supply, such as MABR, It is also part of this invention reactors that include granules or mobile biofilms that enable two independent sludge ages, SRTs, in one bioreactor to further control the CBOD and NBOD degradation. All of these reactors are included in this invention and someone skilled in the art would find alternative ways of achieving NBOD oxidation. In some cases, an embodiment may also include a measurement of ammonia in the influent to the bioreactor such as 14 and combine those measurements with the effluent measurements to provide input to flow control decision-making by the monitoring and control subsystem 241. A large variety of control strategies such as PID controls, sampling times, sampling responses, dead bands, and others can then be devised to reach the desired conversion under dynamic conditions typical of operations and someone skilled in the art can find alternative controls strategies. However, the underlying common control structure is based on measuring a concentration of substrate for nitrification in the bioreactor or in the effluent to the bioreactor, namely, ammonia or ammonium or total ammonia nitrogen, or measuring the products of nitrification, namely nitrate or nitrite or both, or gaseous products like nitric oxide or nitrous oxide or all of them. Optionally, the influent concentration of total nitrogen or ammonia nitrogen influent to the bioreactor is measured, said measurements are processed and the influent flow rate to the bioreactor is controlled using the monitoring and control subsystem 241 to achieve a desired effluent of ammonia, ammonium, nitrate, nitrite or a combination of those. The effluent ammonia or ammonium, or total ammonia NHx, or nitrate, or nitrite can be then set to a desired set point, or a desired range of concentrations, and the influent flow rate to the nitrifying bioreactor controlled to achieve the desired effluent condition. Influent flow control to the nitrifying bioreactor can be achieved directly at the influent location of the two-sludge process 12 or directly at the influent location of the nitrifying bioreactor 21.

FIG. 1B illustrates yet another embodiment 12 to this invention where the first stage 1 for CBOD removal is carried out using a roughing bioreactor 11 such as but not limited to a moving bed biofilm reactor, MBBR, or a fluidized bed bioreactor. No secondary clarifier 111 is shown in FIG. 1B after oxidation of CBOD in the first bioreactor; however, in some embodiments the CBOD roughing bioreactor might have an internal solid-liquid separator. A significant amount of heterotrophic organisms are likely present in the carbon-reduced wastewater and transferred to the nitrifying second-stage bioreactor 21 due to biofilm sloughing in the first bioreactor. The second stage 2 is in all aspects similar to that previously described in FIG. 1A. Control of the conversion of ammonia of the nitrification reaction in the second stage is also similar to the previous description for FIG. 1A. An optional return of mixed liquor 20 from the second stage 2 to the first stage 1 is presented here, this is advantageous as it enables nitrification reactions to take place in the first stage without interfering with the SRT control for CBOD as this is done by the sloughing of biofilm.

FIG. 1C illustrates yet another embodiment of the present invention where the labelled components are consistent with those described in previous embodiments and best applied when the influent carbonaceous CBOD is relatively low and there is no advantage to using a first-stage 1 high-rate CBOD removal system. In this case, influent wastewater 30 is delivered directly to the nitrifying bioreactor 21. Many different types of bioreactors 21 can be used for oxidizing NBOD; suspended-growth reactors, biofilm reactors with mobile or static biofilms, flocculent or granular sludge, biofilm reactors with membranes for support with or without aeration or alternatives of oxygen supply, as MABRs, some bioreactors such as granular sludge bioreactors or biofilm bioreactors, mobile or static biofilm, might actually incorporate different sludge ages for microorganisms in biofilm or granules and organisms in floc further providing flexibility to the NBOD oxidation. All these different types of reactors form part of this invention and someone skilled in the art would find alternative ways of achieving NBOD oxidation. Depending on the nitrifying bioreactor 21 type and use of the treated effluent 40 downstream an optional solid-liquid separator 211 is used in this embodiment. For example, as in some agro-industrial applications for direct use of the controlled NBOD treated liquid 27 as fertilizer that is compliant with the NOP rules and regulations, nitrification can take place in a biofilm-based bioreactor and no there is no need for a solid-liquid separation process. Yet in other cases a solid-liquid separation 211 similar to the previously described in FIG. 1A or FIG. 1B is incorporated and treated effluent 40 can be directed for NOP fertilizer use. A large variety of solid-liquid separation processes 211 can be used such as but not limited to clarifiers, flotation units, ultrafiltration membranes or microfiltration membranes. Someone skilled in the art would find the most appropriate solid-liquid separation process for a particular application. Influent wastewater 30 flow control is conducted as previously described in FIG. 1A to achieve a desired conversion of ammonia in the NBOD treated liquid 27.

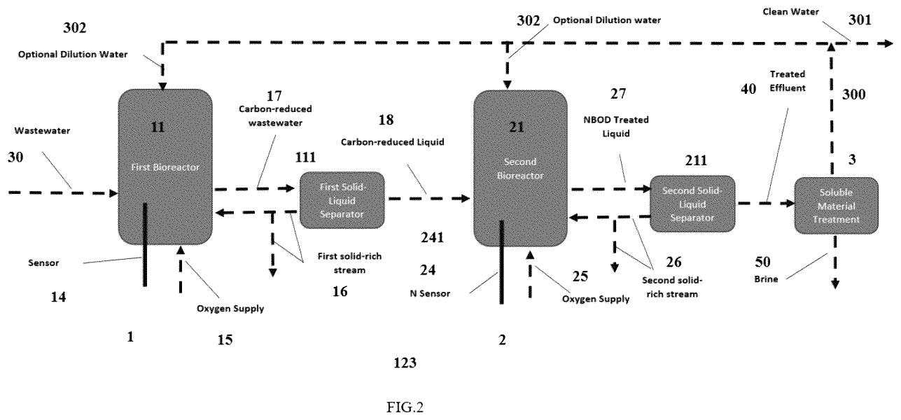

FIG. 2 illustrates yet another embodiment 123 of the present invention with the two-sludge process 12 as previously presented in FIGS. 1A, 1B and 1C with further removal of nitrogen and phosphorus downstream of the treated effluent 40 using a soluble material treatment process 3 such as but not limited to nanofiltration, reverse osmosis, evaporation, or capacitive deionization, or a combination. In some embodiments the solid-liquid separation process 211 is an ultrafiltration or microfiltration membrane, as is the case when the second stage is a membrane bioreactor, MBR, while in other cases the solid-liquid separation process is not a membrane process but a clarifier, a dissolved air flotation unit, a filter or other types of separation units. When the solid-liquid separation process is not a membrane process, a pretreatment process such as filtration or ultrafiltration or microfiltration may be necessary to adjust the conditions of the treated effluent prior to further processing in a soluble material treatment process. This embodiment 123 is particularly beneficial for applications involving industrial and agricultural wastewaters with high contents of nitrogen, i.e., above 100 mg/L of total nitrogen in the raw wastewater. Toxicity of ammonia is further controlled by recirculating clean water 300 with low soluble material content that is produced after passing the treated effluent from the two-sludge process through the soluble material treatment, to the first and/or second stage bioreactor. The recirculated stream is thus used as dilution water 302 to further reduce ammonia concentration and its toxicity in the first 11 and/or second bioreactors 21. Use of dilution water for toxicity control of ammonia in stages one or two of the two-sludge process is not restricted to recirculated clean water; water with low concentration of ammonia from other sources can be directly mixed with wastewater to be treated or added to either of the two stages for diluting ammonia concentration. A brine 50 is produced as a second stream of the soluble material treatment process and this brine can be reused directly in some cases as organic fertilizer compliant with NOP rules and regulations or further concentrated in ZLD type processes depending on the local conditions for reuse or disposal of brines. The excess clean water that is not recirculated upstream of the process as dilution water is high quality reuse water 301 that can be locally utilized.

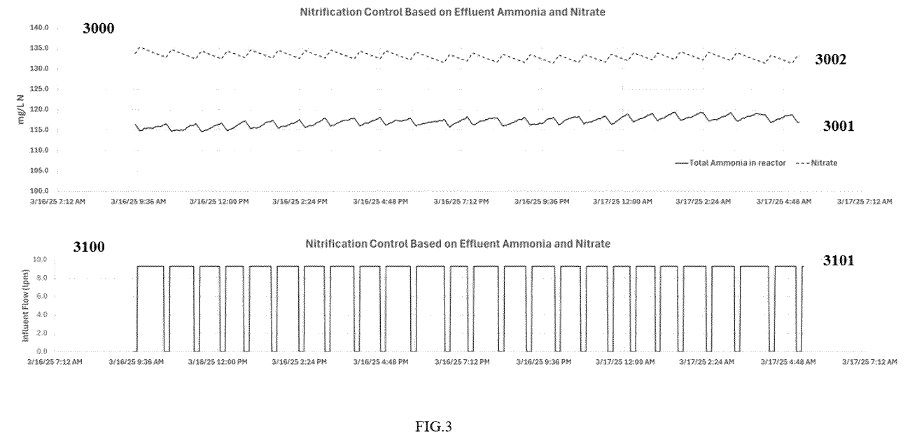

FIG. 3 illustrates an exemplary use of a monitoring and control subsystem 241 according to an embodiment of this invention wherein said monitoring and control subsystem is measuring ammonia and nitrate in the nitrification reactor and using the said measurement of ammonia to control the influent flow to the nitrification reactor. The concentration of nitrate was also measured but was not directly used in this case for control; however, in some embodiments, either the ammonia or the nitrate, or nitrite concentration or all could be used as part of the control logic of the process used in 241. Two graphs are presented in FIG. 3; the top graph 3000 has plotted measurements of concentration of nitrate 3002 and ammonia 3001 over time in the nitrification reactor while the bottom graph 3100 has plotted measurements of the flow rate 3101 that the influent pump was delivering to the reactor over time in liters per minute, lpm. The area under the curve in this bottom graph is the volume delivered for each time period over which the influent pump was active. A dead band control was used in this example where upper and lower limits of ammonia were used for activation or deactivation of the pump causing the signal of ammonia to oscillate within a range. In this case, the concentration of ammonia oscillated within 115 and 120 mg/L, while nitrate oscillated within 135 mg/L and 130 mg/L. Controlling of ammonia within that range avoids all use of external alkalinity, nitrate conversion to nitrogen gas in denitrification process is avoided and oxygen demand for full nitrification conversion to nitrate is also reduced.

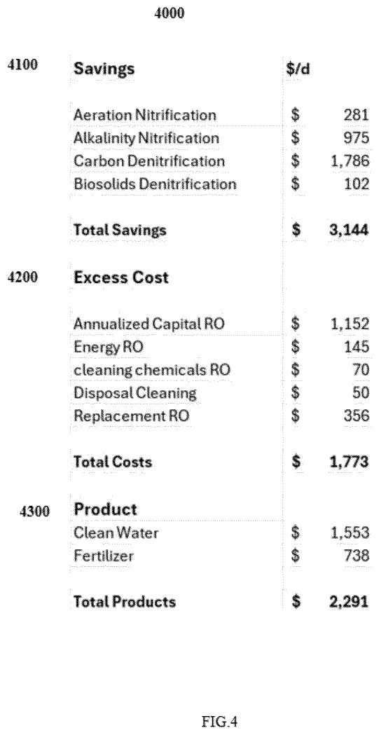

An example 4000 of the cost effectiveness for industrial wastewater treatment of the present invention is presented in FIG. 4. Firstly, estimated savings 4100 for treatment of an industrial wastewater from an egg processing facility with the present invention versus with prior art including nitrification and denitrification are presented. The conditions used in this example for the facility wastewater, egg processing wash water, are 750,000 gallons per day of wastewater with 853 mg/L of BOD5, 295 mg/L of TKN and 419 mg/L of alkalinity as CaCO3. Due to the relatively low BOD to TKN ratio, conventional nitrification and denitrification treatment requires use of external alkalinity in the form of magnesium hydroxide for pH control and an external carbon source, in this case glycerol, for denitrification. Use of external carbon allows the recovery of both oxygen and alkalinity, thus reducing the demands of both. However, the addition of external carbon increases the production of biosolids for disposal due to bacterial growth associated with heterotrophic denitrification. An embodiment according to the present invention provides 45% savings in nitrification needs due to reduction in the amount of ammonia oxidized, 100% savings in external alkalinity required since nitrification is conducted in a manner in which only incoming wastewater alkalinity is used, avoidance of 100% of the carbon demands for denitrification as no denitrification is conducted as presented in FIG. 3, and avoidance of 100% of excess biosolids disposal costs associated with external carbon use for denitrification. Next presented in FIG. 4 are the additional expenses, excess cost, 4200 in capital and in operation when utilizing the present invention that are associated with a reverse osmosis, RO, unit for concentrating the nitrified effluent. Lastly presented in FIG. 4 is the value of the two products 4300 that are a result of implementing the RO system in the present embodiment—high quality treated water for reuse at the industrial plant, and a concentrated fertilizer containing the half-nitrified nitrogen. The values in FIG. 4 for savings 4100, extra costs 4200, and value of products 4300 are all normalized to dollars per day of operation. The total savings for reduction in aeration, alkalinity and carbon amount to $3,144 per day, while the extra expenses associated to capital for RO purchase, and operational energy, cleaning chemicals, replacement of membranes and disposal of cleaning chemicals amount to $1,773 per day. The sale of the two products from the system, clean water for reuse and fertilizer, amount to $2,291 per day. The net of savings, costs and product sales is $3,662 per day; thus, it is evident that there are significant economic advantages in using the system of the current invention when compared to prior art. Furthermore, the system provides more sustainable industrial operation with reuse of water and nutrient recovery for agriculture.

For the purpose of this invention: (a) A two-sludge process, or two-sludge system, is, as its name describes, a process or a system with two sludge systems in series, a first stage, and a second stage, each with first and second bioreactors and optional first and second solid-liquid separators, and the first stage system receiving the wastewater to be treated containing CBOD and NBOD and the second stage system receiving the effluent of the first system. The wastewater received for treatment may have been previously treated to remove settleable solids, grit, or rags, or other components that might interfere with the process. Each of the stages are operated at different loading rates and sludge residence times in such a way that the first stage is mostly a carbonaceous BOD removal system, while the second stage is a nitrogenous BOD processing system conducting nitrification reactions biologically oxidizing ammonia to nitrite and nitrate or a combination of nitrate and nitrite. The microbiological characteristics of the sludge, or biofilm, that forms on each of the systems are different; the first sludge is comprised of mostly heterotrophic microorganisms while the second sludge comprises microorganisms that oxidize nitrogenous compounds. The solid-liquid separation units in each of the stages are units such as but not limited to clarifiers, air flotation units, filters, microfiltration or ultrafiltration units. The use of roughing treatment processes for removal of carbonaceous BOD such as but not limited to the moving bed biofilm reactor, MBBR, or fluidized bed reactors with high loading rates, are considered as first-stage sludge systems for the purpose of this invention even though in these roughing processes no returned sludge is practiced in the first stage as the biofilm growing in the media is retained within the bioreactor. The roughing process used for CBOD removal might incorporate an internal clarifier. The first bioreactor in FIG. 1A might include an anaerobic stage within the bioreactor where the return sludge from the first liquid separator is directed to be in contact with the influent wastewater in such a way that biological phosphorus removal is obtained; no denitrification reactions are encouraged as effluent recirculated for pH control is downstream of the clarifier. Other biological phosphorus removal, such as but not limited to Phoredox, Phostrip or A/O, can be incorporated in this configuration and someone skilled in the art would find it apparent. Wastewater is considered any pumpable waste that can be treated with an activated sludge system and contains CBOD and NBOD, including but not limited municipal or industrial effluents, effluents from processing of manures, or ammonia condensates or distillates, or landfill leachates. (b) A soluble material treatment process optionally incorporates an ultrafiltration or a microfiltration membrane or filters as necessary to prepare the effluent from the second solid-liquid separator to be adequately processed in said soluble material treatment process.(c) Nitrification reactions include the biological oxidation of ammonia to nitrite, nitrate or a combination of nitrite and nitrate, some gases might be formed in the nitrification process namely nitric oxide or nitrous oxide.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

1. A method for treating wastewater by:
a. treating wastewater in a two-sludge process where the second bioreactor is conducting nitrification reactions,
b. measuring the concentration of at least one of ammonia, ammonium, nitrite or nitrate in the first bioreactor, or the second bioreactor, or both bioreactors, obtaining a nitrogen measurement,
c. controlling the influent flow rate to at least one of the first or the second bioreactor based on said nitrogen measurement to keep said nitrogen measurement within a set point, or a range with no addition of alkalinity other than that contained in influent wastewater,
d. optionally adding alkalinity other than that contained in influent wastewater to the second bioreactor if the fraction of influent total nitrogen that is nitrified is larger than 50%,
e. collecting the treated effluent.

2. The method of claim 1 where the treated effluent is further treated with a soluble material treatment process forming a clean water stream and a brine stream.

3. The method of claim 2 where a fraction of the clean water stream is returned as dilution water to either the influent flow, or the first stage, or the second stage or a combination of said locations.

4. The method of claim 1 where either or both of the first and second solid-liquid separators is a clarifier, an air flotation or a membrane process such as but not limited to microfiltration or ultrafiltration or a combination of clarification and membrane processes.

5. The method of claim 2 where the soluble material treatment process is a reverse osmosis process or a thermal evaporation process or an electrodialysis process or a capacitive deionization process or other electrochemical soluble material treatment process.

6. The method of claim 1 where dilution water from an external source is added to either the influent flow, or the first stage, or the second stage or a combination of them.

7. The method of claim 2 where the brine produced is used as fertilizer according to the rules and regulations of the USDA national organic program.

8. A method to control ammonia toxicity and nitrification in a nitrifying bioreactor by:
a. measuring the concentration of at least one of ammonia, ammonium, nitrite, or nitrate in said bioreactor obtaining a nitrogen measurement,
b. controlling the influent flow rate to said bioreactor based on said nitrogen measurement to keep said nitrogen measurement within a set point or a range with no addition of alkalinity other than that contained in the influent wastewater,
c. adding dilution water to the bioreactor as needed to reduce ammonia concentration,
d. optionally adding alkalinity if the fraction of influent ammonia that is nitrified is larger than 50%.

9. The method of claim 8 where treated effluent from the controlled nitrification bioreactor is further treated with a soluble material treatment process forming a clean water stream and a brine stream.

10. The method of claim 9 where at least a fraction of the clean water stream is recirculated as dilution water to reduce the concentration of ammonia in the bioreactor.

11. The method of claim 8 where the controlled nitrification bioreactor has an effluent solid-liquid separator such as but not limited to a clarifier, an air flotation or a membrane process such as microfiltration or ultrafiltration or a combination of said solid-liquid separators.

12. The method of claim 9 where the soluble material treatment process is a reverse osmosis process or a thermal evaporation process or an electrodialysis process or a capacitive deionization process or other electrochemical soluble material treatment process, or a combination of said processes.

13. The methods of claim 8 or 11 where the effluent of the bioreactor is used as fertilizer according to the rules and regulations of the USDA national organic program.

14. The method of claim 9 where the brine produced in the soluble material treatment process is used as fertilizer according to the rules and regulations of the USDA national organic program.

15. A system for treating wastewater comprising: a wastewater source, a two-sludge subsystem where the second bioreactor is a nitrifying bioreactor, one or more nitrogen measurement and control subsystem(s) measuring at least one of an ammonia sensor, or an ammonium sensor, or a nitrite sensor, or a nitrate sensor, means for controlling the influent wastewater flow to the bioreactors, an optional source of alkalinity, and pipes, valves, fittings, connectors, pumps and appurtenances to fluidly connect the above-mentioned parts of the system, and whereby:
a. the wastewater source is fluidly connected to at least one inlet to the two-sludge subsystem,
b. the nitrogen measurement and control subsystem is connected to at least one of the first bioreactor or the nitrifying bioreactor and configured to measure at least one of the influent ammonia to the bioreactor or at least one of bioreactor concentration of ammonia, ammonium, nitrate or nitrite, forming a nitrogen measurement,
c. the influent flow to the first bioreactor, the nitrifying bioreactor or both bioreactors is controlled by the nitrogen measurement and control subsystem to keep the nitrogen measurement within a set point or a range with no addition of alkalinity other than that contained in the influent wastewater,
d. the source of alkalinity is fluidly connected to either of the two bioreactors and alkalinity is optionally added when the conversion of nitrogen is higher than 50% as measured,
e. the treated effluent is collected.

16. The system of claim 15 where no first bioreactor is present, and the influent wastewater is sent directly to the nitrifying bioreactor and dilution water is added as needed to control ammonia toxicity.

17. The system of claim 15 or 16 further comprising a soluble material treatment unit such as a reverse osmosis unit or a thermal evaporation unit or an electrodialysis unit or a capacitive deionization unit or other electrochemical soluble material treatment unit, or a combination of said processes, and the treated effluent is directed to said soluble material treatment unit forming a clean water stream and a brine stream.

18. The system of claim 17 where the clean water stream of the soluble material treatment unit has a fluid connection to any of the bioreactors and at least a fraction of the clean water is directed as dilution water to reduce the concentration of ammonia in the bioreactor.

19. The system of claim 17 where the clean water stream of the soluble material treatment unit is directed for aquifer recharge, saline water intrusion control, irrigation or industrial or agro-industrial uses such as but not limited cooling tower make up, wash water, flush water for manure, cleaning water, or others.

20. The system of claim 17 where the concentrated brine of the soluble material treatment unit is used as fertilizer according to the rules and regulations of the USDA National Organic Program.
